(19) United States
(12) Patent Application Publication
(10) Pub. No.: US 2002/0134962 A1
(43) Pub. Date: Sep. 26, 2002

(54) Phase change material for maintaining refrigerated temperatures

(76) Inventor: Benjamin Romero, Lyndhurst, NJ (US)

Correspondence Address: BENJAMIN ROMERO, 567 KINGSLAND AVE., LYNDHURST, NJ, 07071, US

(21) Appl. No.: 09/681,356

(22) Filed: Mar. 25, 2001

(51) Int. Cl. F25D 1/00; C09K 5/00

(52) U.S. Cl. 252/70; 62/56; 252/71

(57) ABSTRACT

A new use for hydrocarbons, phase changing at temperatures above the freezing point of water, by which their latent heat is used to protect temperature sensitive product during shipment. The phase change material is used in shipping containers by packaging the material in flexible or rigid sealed containers, and surrounding the temperature sensitive products with a calculated amount of phase change material.

### BACKGROUND OF INVENTION

This invention relates to the field of temperature control packaging, specifically to the use of a new phase change material for temperature control of packages at refrigerated temperatures.

It is a known fact that certain consumer products need to be maintained at specific temperatures, in most cases at refrigerated temperatures. Refrigerated temperatures typically include the range between 2 and 8 degrees Celsius. Consumer products affected by this requirements are usually food, drugs and other perishables. Industry spends millions of dollars a year in temperature controlled packaging. This includes packaging materials, validation and design of packages, storage of materials and shipping and storing this temperature sensitive products between departments within a manufacturing facility, to distributors and consumers.

Packaging for these goods, which must be refrigerated, typically include a Phase change material, and insulation. Typical insulation includes EPS (Expanded polystyrene) foams, Urethane, VIP (vacuum insulated panels), and others. While insulation for these products is diverse and provides solutions to different package performance requirements, the Phase change material used are a range of water based Gels. Water based Phase change materials will freeze at the freezing point of water, namely 0° C. This means that they will try to maintain a temperature of 0° C. (32° F.). Unfortunately, the majority of drugs and medications can not be exposed to temperatures below 2° C., namely they have to be maintained refrigerated and cannot freeze (0° C. or below). This causes a variety of problems while designing a package to maintain refrigerated temperatures, if using a water based phase change material; the PCM (phase change material) will try to maintain 0° C., which would spoil the temperature sensitive product. Some techniques, like using a combination of refrigerated and frozen water based PCM's, provide a solution, but at a very expensive price. Using water based PCM's in two different states (solid, liquid) will increase the size and weight of the package, thus making it more expensive to ship; also, this method requires that the company manufacturing the temperature sensitive product stock PCM's in freezers and refrigerators, a costly proposition. Other minimally effective techniques include the use of packing materials (peanuts, paper, bubble wrap, and such), to separate the refrigerated product from the frozen PCM; this also makes for a heavier, larger, more expensive, harder to pack and validate package. The company does not need to condition such materials, but does need to stock them within the facility.

Because FDA regulated companies (drug, medical device, food etc.) are responsible for protecting their products during shipping, their shipping containers must be validated to prove their efficacy in maintaining the temperatures by which their product has been approved, typically refrigerated temperatures. Validation of such packages using water based PCM's is a tedious, time consuming challenge, which involves testing of different packaging configurations under various varying environmental conditions (i.e. summer/winter temperature profiles); this is a hardship mainly because of the use of water based PCM's to protect the product from the various environmental conditions. This testing process is an added cost to the company manufacturing the temperature sensitive product. For example, a pharmaceutical company which manufactures a temperature sensitive product in Puerto Rico, and needs to ship it to different distributions centers in the US and Europe, will have to design and validate packaging configurations to assure that their drug does not become useless or even harmful, after exposure to different climates, both hot and cold, for different amounts of time. In the same way that standard shock requirements are devised for fragile components, temperature requirements must be met for temperature sensitive products. Once again, the use of water based PCM's only makes the inherently complex proposition to validate such packages even more difficult; several iterations of testing including a variety of packaging arrangements, including number and weight of PCM's, amount and type of insulation used, amount of filler material used (peanuts, bubblewrap etc.) and other variables need to be tweaked to allow for the validation of a package under standard shipping environmental conditions.

In summary, the key concept to realize is that the lower end of the refrigerated temperature range is above the freezing temperature of water, namely 0 degrees Celsius (32 Fahrenheit). This fact makes the current PCM's used worldwide inherently inefficient, since they are water based. A highly efficient and practical PCM needs to be identified for use with products which need to be maintained at refrigerated temperatures.

### SUMMARY OF INVENTION

The use of hydrocarbons in the field of packaging, to efficiently maintain refrigerated temperatures within shipping containers.

### BRIEF DESCRIPTION OF DRAWINGS

In the drawings, closely related figures have the same number but different alphabetic suffixes.

FIGS. 1A to 1C show different views of a typical bag filled with PCM.

FIG. 2 shows PCM bags being used in a typical insulated package.

### DETAILED DESCRIPTION

The use of normal hydrocarbons provides a highly efficient solution to the problem of shipping products or materials which need to be kept refrigerated. Standard commercially available cuts of normal paraffins (hydrocarbons) phase change at refrigerated temperatures, have good heat of fusion and are safe to use.

The PCM, is a readily available chemical, which can be purchased from several sources. The biggest producers are Exxon and Condea. Exxon markets fluid hydrocarbons which phase change in the refrigerated temperature range under the Norpar name; examples are Norpar 14 and Norpar 15.

Condea markets fluid hydrocarbons which phase change in the refrigerated temperature range under the Linpar name; examples are Linpar 14, Linpar 14-16V, and Linpar 14-17. Condea

All the commercially available PCM's (i.e. Linpar 14, Norpar 15) and others not listed are hydrocarbons, with slight differences between them (i.e. variation in n-paraffin cut). The best choice of hydrocarbon will be the one which is best for a particular application. Price, safety, performance and exact Phase change temperature are the factors which will decide which particular hydrocarbon will be used in a specific application. This new use for these existing materials, differs completely from their current applications which include: intermediates in the manufacture of surfactants, intermediates in the manufacture of chloroparaffins; production of oils for aluminum cold rolling catalyst carrier for olefin polimerization; all-purpose solvent and diluent, when a solvent molecule of low polarity is required; premium-grade solvent, where an odour-free product is required, as in the production of printing inks for good packaging; low-smoke fuel for patio torches.

The PCM (phase change material) can be packaged in several ways to allow it to perform in the temperature control packaging application. Many standard packaging materials are compatible with it, and are suitable. Such materials include materials which will minimize the risk of leakage due to the puncture or breakage of the packaging material or seal; such an occurrence could destroy the shipment, if the PCM were in liquid state. The choice of materials, will greatly depend on the product being shipped, the method of shipment, and the amount of shock protection employed in the package. For most applications, Polyethylene film can be used. Polyethylene film offers great leak protection while being easy to form into bags and being relatively inexpensive.

For more critical applications, another choice of packaging film could be made.

For example, Allied Signal has a specialty nylon film, which is specially suited for packaging hydrocarbons; the product family is Capran Emblem Biax Nylon films. For expensive product, or for product which could absolutely not come in contact with the PCM, other packaging could be used. Anyone in the field of packaging can easily resource a stronger film or a rigid leak proof container which could accomplish the task.

Using a standard Vertical Fill Form Seal machine, the bags could be filled, formed and sealed, finalizing the product. Such machines are manufactured by several companies in the packaging industry, and are readily available; an example of a manufacturer of Vertical Fill Form Seal equipment is Key-Pack Machines.

Essentially, the PCM could be packaged in the same way that gel packs with water based PCM's are packaged. Currently, polyethilene bags and Vertical form fill seal equipment are the standard material and method for packaging the common ice pack (water based).

Standard form fill seal packaging equipment could be used to create this polyethylene bags, which would provide a good compromise between leak protection and price.

The packaged PCM would be used in a similar manner as the common water based gel pack, within an insulated package. The same heat transfer calculations would apply, only instead of using a water based gelpack, a hydrocarbon would be used. The properties of the specific hydrocarbon (i.e. heat of fusion, melting point) would determine the amount of PCM to be used, where the PCM would be placed with respect to the product, and how much insulation would be used.

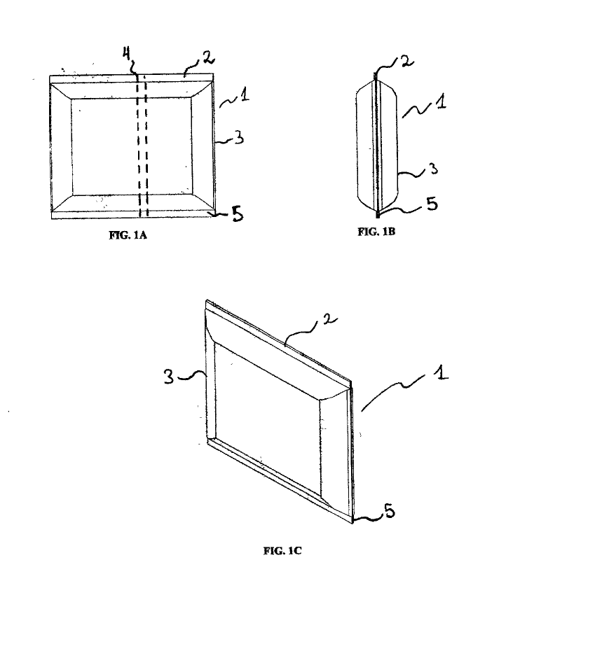

A typical embodiment of the packaged PCM of the present invention is illustrated in FIG. 1A (top view), FIG. 1B (side view), and FIG. 1C (isometric view). The bag 1, sealed with a vertical form, fill, seal machine has a top seal 2, a bottom seal 5 and a vertical seal 4. The PCM bag material 3 can be any hydrocarbon compatible material, like polyethilene. Other tougher compatible materials, commercially available will provide better puncture resistance, at a higher price; examples are high density polyethilene, biaxial multilayer polyethiline, nylon films. Molded rigid packaging is another option if puncture resistance or reusability are critical requirements; an example of process/material is blowmolded polyethilene.

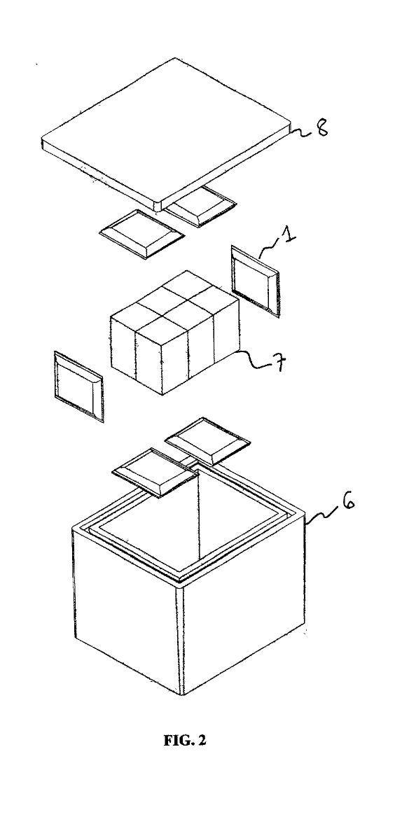

FIG. 2 shows an exploded view of the packaged PCM used in a typical temperature control shipping application. An foam cooler 6 provides the insulation which slows down the heat transfer between the inside of the cooler and the outside environment; the cooler 6 also absorbs energy in case of shock and vibration encountered during shipping. Bags filled with hydrocarbon phase change material 1 are placed surrounding the temperature sensitive material 7 being shipped. Once the PCM bags 1 and the material being shipped 7 are placed in the insulated cooler 6, the cooler 6 is sealed with the corresponding foam lid 8.

If the package was shipped in the summer, and the shipped material 7 needed to stay refrigerated, the PCM would be preconditioned to about 1 degree Celsius, or just above the freezing temperature of water; at such temperature, the PCM would be frozen and ready to absorb energy from the warm summer environment, as it changed from solid to liquid, thus protecting the shipped material. On the other hand if the package was shipped in the winter, and the shipped material 7 needed to stay refrigerated, the PCM would be preconditioned to a temperature above its freezing point (for example 10 degrees Celsius); at such temperature, the PCM would be liquid, and ready to release energy into the colder winter environment, as it changed from liquid to solid, thus protecting the shipped material.

1. A method for maintaining the temperature within a shipping container at refrigerated levels comprising the use of a hydrocarbon in an amount sufficient to protect the shipment.

2. A method for protecting temperature sensitive materials comprising surrounding the materials with hydrocarbons in an amount effective to maintain the product's temperature within a specified range.

3. A method for protecting temperature sensitive products comprising surrounding such products with hydrocarbons in an amount effective to maintain the product's temperature above zero degrees celsius.
